(19) United States
(12) Patent Application Publication
(10) Pub. No.: US 2002/0100175 A1
(43) Pub. Date: Aug. 1, 2002

(54) Trailer alignment apparatus

(76) Inventor: Clarence D. King, Waskom, TX (US)

Correspondence Address: John M. Hasrrison, 2139 E. Bert Kouns, Shreveport, LA, 71105, US

(21) Appl. No.: 09/771,060

(22) Filed: Jan. 29, 2001

(51) Int. Cl. B60D 1/40

(52) U.S. Cl. 33/264; 33/286; 116/28 R

(57) ABSTRACT

A trailer alignment apparatus for facilitating alignment of the ball coupler on a gooseneck trailer or a tongue-mounted coupling trailer with the hitch ball on a towing vehicle. In a first embodiment, the trailer alignment apparatus is designed for use with gooseneck trailers and mounts in the bed of a pickup truck and supports a pivoting alignment indicator over the hitch ball in the truck bed. As the pickup truck is backed toward the stationary gooseneck trailer, the alignment indicator eventually contacts the vertical gooseneck hitch post on the trailer and pivots from an angled to a vertical position to indicate to the pickup truck driver that the gooseneck-type ball coupler on the hitch post is in precise vertical alignment with the hitch ball. In a second embodiment, the trailer alignment apparatus is designed for use with tongue-mounted coupling trailers and is typically mounted on the rear bumper of a truck or other towing vehicle and extends rearwardly from the vehicle, such that the pivoting alignment indicator is positioned above the rearwardly-projecting hitch ball on the vehicle. A target device is mounted on the tongue of the trailer and extends above the tongue-type ball coupler of the trailer for engaging and pivoting the alignmemt indicator as the towing vehicle is backed to a position where the coupler is disposed in direct overhead alignment with the hitch ball.

### BACKGROUND OF THE INVENTION

1. Field of the Invention

This invention relates to trailer coupling and trailer hitch alignment devices and more particularly, to a trailer alignment apparatus which in a first preferred embodiment is designed for use with goosneck-type trailers. The trailer alignment apparatus includes an L-shaped support bracket which is mounted on one side of the bed of a pickup truck and receives a selectively-extendible adjusting rod fitted with a pivoting alignment indicator that is positioned above the hitch ball in the pickup truck bed. The alignment indicator is designed to contact the downwardly-extending gooseneck hitch post carrying a gooseneck-type ball coupler as the truck is backed toward the gooseneck trailer. When the alignment indicator contacts the gooseneck hitch post, it pivots from an angled to a vertical configuration, thus indicating to the driver of the truck that the ball coupler is located directly above the hitch ball in the truck bed. In a second preferred embodiment of the invention, the trailer alignment apparatus is designed for use with tongue-mounted type trailers and is fitted to the rear bumper or other rear structural member of the pickup truck or towing vehicle. The adjusting rod and alignment indicator extend rearwardly of the towing vehicle, with the alignment indicator positioned above a hitch ball attached to the towing vehicle. A target device is fitted to the tongue of the trailer rearwardly of the ball coupler on the tongue, with a target ring element located over the coupler, The target and alignment indicator are positioned such that when the towing vehicle is backed rearwardly toward the trailer, the alignment indicator contacts the target ring and is pivoted from an angled to a vertical configuration, thus indicating to the driver of the towing vehicle that the ball coupler of the trailer is positioned directly over the hitch ball of the vehicle for proper hitching.

One of the problems inherent in hitching various types of trailer coupling devices and trailers to corresponding hitch balls on towing vehicles is that of accurately aligning the coupling device with the hitch ball as the towing vehicle is backed up, without the signaling aid of someone other than the driver of the towing vehicle. The procedure is normally accomplished by trial and error, whether the hitch coupler is of the “gooseneck” design or a ball coupler mounted on the trailer tongue of a trailer of various design. The conventional coupling process can therefore be relatively laborious and time-consuming, since it typically involves multiple adjustments of the towing vehicle with respect to the trailer in order to properly align the towing vehicle ball with the coupling mechanism of the trailer.

2. Description of the Prior Art

Various types of indicating devices and mechanisms are known in the art for aiding in the alignment of trailer hitch balls on towing vehicles with various types of trailer receptacles. Among these are mirror devices that aid the driver of a towing vehicle in aligning the coupling ball with a trailer coupling. Typical patents detailing such mirrors are: U.S. Pat. Nos. 3,295,914, dated Jan. 3, 1967, to Dietrich; 3,524,701, dated Aug. 18, 1970, to Strohmeier; 3,767,292, dated Oct. 23, 1973, to Rutkowski; 4,163,606, dated Aug. 7, 1979, to Granno; 5,309,289, dated May 3, 1994, to Johnson; and 5,825,564, dated Oct. 20, 1998 to Mazarac.

It is an object of this invention to provide a new and improved trailer alignment apparatus for aligning the trailer hitch or coupling mechanism on a gooseneck-type trailer with the hitch ball on a towing vehicle such as a pickup truck, which device includes a support bracket mounted in the pickup truck bed and an alignment indicator connected to the support bracket, which alignment indicator is positioned above the hitch ball in the pickup truck and is designed to pivot from an angled to a vertical configuration as it contacts the vertical gooseneck bitch post element of the stationary gooseneck trailer as the pickup truck is backed up, to indicate when the trailer hitch or coupling mechanism on the hitch post is located directly above the hitch ball.

Another object of this invention is to provide a new and improved trailer alignment apparatus for aligning a hitch ball mounted in the bed of a pickup truck with the gooseneck trailer hitch or coupling apparatus on a gooseneck-type trailer, which trailer alignment apparatus includes an L-shaped support bracket, one end of which is typically removably attached to the side of the pickup truck bed and the other end projecting toward the hitch ball; an adjusting rod adjustably fitted in the support bracket; and a pivoting alignment indicator provided on the extending end of the adjusting rod and positioned above the truck bed and directly over the hitch ball in the line-of-sight of the driver, such that backing of the towing vehicle toward the stationary gooseneck trailer brings the pivoting alignment indicator into contact with the vertically-oriented gooseneck hitch post element of the trailer and causes the moving alignment indicator to pivot to the vertical configuration, thus visually indicating to the pickup truck driver when the gooseneck coupling apparatus is located above the hitch ball for coupling the trailer to the pickup truck.

Yet another object of this invention is to provide a new and improved trailer alignment apparatus for aligning the hitch ball on towing vehicles with the ball coupler of trailer hitches mounted on the tongues of various types of trailers, which apparatus includes a support bracket mounted on the towing vehicle and extending rearwardly of the towing vehicle over the hitch ball; a pivoting alignment indicator provided on the support bracket; and a target fitted to the tongue of the trailer and extending forwardly of the trailer over the ball coupler, such that backing of the towing vehicle toward the target causes the alignment indicator to contact the target and pivot from a sloped or angled configuration to an upright, vertical configuration, such that the vertically-disposed aliment indicator indicates vertical alignment of the ball coupler and the hitch ball.

Still another object of this invention is to provide a trailer alignment apparatus which is characterized by an L-shaped support bracket removably mounted on the rear bumper or other rear structural member of a towing vehicle fitted with a hitch ball an adjusting rod slidably fitted in the support bracket and provided with a pivoting alignment indicator at the extending end thereof, which aliment indicator extends rearwardly of the towing vehicle and is located over the hitch ball; and an L-shaped target device, one end of which is mounted on the tongue of the trailer and the other end projecting forwardly of the trailer, with a target ring attached to the extending end of the adjusting rod and positioned over the ball coupler provided at the end of the trailer tongue, such that backing of the towing vehicle toward the station trailer causes the lower segment of the alignment indicator to contact the target ring on the target and the alignment indicator to pivot into vertical configuration, thus aligning the ball coupler immediately above the hitch ball for coupling the trailer to the towing vehicle.

### SUMMARY OF THE INVENTION

These and other objects of the invention are provided in a new and improved trailer alignment apparatus for aligning the bitch ball on a towing vehicle such as a pickup truck with the coupling mechanisms of both gooseneck trailers and trailers of the type characterized by an elongated trailer tongue. In a first preferred embodiment, the trailer alignment apparatus is characterized by an L-shaped support bracket, one end of which is removably attached to the upper side of a pickup truck bed and the other end projecting toward a hitch ball mounted in the pickup truck bed; an adjusting rod slidably and adjustably extendible from the support bracket; and a pivoting alignment indicator attached to the end of the adjusting rod, which alignment indicator normally rests at an angle with respect to the vertical and is located above the hitch ball, such that backing of the pickup truck toward a gooseneck trailer causes the alignment indicator to pivot into vertical configuration as it is advanced against the downwardly-extending, vertical hitch post portion of the gooseneck trailer and indicates vertical alignment of the gooseneck-type coupler on the hitch post with the underlying hitch ball on the towing vehicle. In a second preferred embodiment of the invention, the trailer alignment apparatus is fitted to the rear bumper or other rear structural member at the rear of the towing vehicle and extends upwardly and rearwardly of the towing vehicle, with the alignment indicator pivotable in a vertical plane perpendicular to the adjusting rod element of the bracket. The target apparatus is typically attached to the tongue of the trailer and supports a target ring over he ball coupler, which target ring is horizontally aligned with and spaced from the aliment indicator. As the towing vehicle is backed toward the trailer, the alignment indicator contacts the target ring and pivots upwardly into the vertical configuration to indicate vertical alignment of the ball coupler with the underlying trailer hitch ball.

### BRIEF DESCRIPTION OF THE DRAWINGS

The invention will be better understood by reference to the accompanying drawings, wherein:

FIG. 1 is a perspective view of a first preferred embodiment of the trailer alignment apparatus of this invention, mounted in the bed of a pickup truck (shown in phantom), with the pivoting indicator element disposed in an angle, resting position with respect to the vertical over the hitch ball in the truck bed and advancing with the pickup truck toward the downwardly-extending gooseneck hitch post of a gooseneck trailer (also in phantom), as the truck is backed toward the gooseneck-type coupling on the hitch post of the trailer;

FIG. 2 is a side view, taken along line 2-2 of the trailer alignment apparatus illustrated in FIG. 1, more particularly illustrating the alignment indicator element of the trailer alignment apparatus in close proximty with the downwardly-extending gooseneck hitch post of the gooseneck trailer;

FIG. 3 is a side view, taken along line 2-2 of the trailer alignment apparatus illustrated in FIG. 1, with the alignment indicator pivoted into vertical contact with the downwardly-extending gooseneck hitch post, thus indicating vertical alignment of the gooseneck-type ball coupler on the hitch post with the underlying hitch ball in the truck bed;

FIG. 4 is a perspective view of the trailer alignment apparatus illustrated in FIGS. 1 and 2, more particularly illustrating a preferred, removable mounting of the support bracket element of the apparatus on the bed of the pickup truck, illustrated in section by dashed lines;

FIG. 5 is a side section a view of the pivoting alignment indicator element of the trailer alignment apparatus illustrated in FIGS. 1 and 2, more particularly illustrating the alignment indicator in the angular, non-contact configuration;

FIG. 6 is a side sectional view of a preferred embodiment of the alignment indicator element of the trailer alignment apparatus illustrated in FIG. 3, more particularly illustrating the alignment indicator in the vertical contact configuration in application of the trailer alignment apparatus;

FIG. 7 is a side sectional view of the engaged support bracket and adjusting rod elements of the trailer alignment apparatus illustrated in FIGS. 1-6, more particularly illustrating a linear adjusting feature of the adjusting rod element with respect to the support bracket element;

FIG. 8 is a rear view, partially in section, of a preferred alignment indicator of the trailer alignment apparatus illustrated in FIGS. 1-6, more particularly illustrating a pair of pins fixed in the extending end of the adjusting rod to facilitate proper initial positioning of the pivoting indicator on the support rod prior to contact of the pivoting indicator with the gooseneck hitch post trailer element illustrated in FIGS. 1-3 of the drawings;

FIG. 9 is a perspective, exploded view of the trailer alignment apparatus illustrated in FIGS. 1-6, more particularly illustrating a preferred mounting of the pivoting indicator on the extending end of the adjusting rod as illustrated in FIG. 8 and a preferred cleat or bracket for removably mounting the support bracket to the upper side of the truck bed;

FIG. 10 is a perspective view of a second preferred embodiment of the trailer alignment apparatus, more particularly illustrating mounting of the support bracket on the rear bumper of a pickup truck and use of a companion target element mounted on the tongue of a conventional trailer having a tongue-mounted ball coupler, to facilitate vertical alignment of the ball coupler with the underlying trailer hitch ball;

FIG. 11 is a side view of the trailer alignment apparatus and target illustrated in FIG. 10, more particularly illustrating contact between the alignment indicator of the trailer alignment apparatus and the target ring element of the target, to facilitate vertical orientation of the pivoting aliment indicator which indicates vertical alignment of the ball coupler over the hitch ball;

FIG. 12 is a side view of the trailer alignment apparatus and target illustrated in FIG. 11, with the alignment indicator and target ring spaced apart to indicate a typical position of the alignment indicator prior to contact between the pivoting alignment indicator and the target ring on the target as the towing vehicle is backed toward the trailer;

FIG. 13 is a perspective view of the trailer alignment apparatus and target illustrated in FIG. 12, more particularly illustrating a preferred method for removably mounting the trailer aliment apparatus on the rear bumper of a pickup truck and the target on the tongue of the trailer;

FIG. 14 is a perspective, exploded view of the trailer alignment apparatus illustrated in FIGS. 10-13, more particularly illustrating a preferred configuration for the support bracket component of the apparatus to facilitate easy removal and adjustment of the adjusting rod and the alignment indicator;

FIG. 15 is a perspective, exploded view of a preferred target element, more particularly illustrating a preferred removable mounting of the target on the trailer tongue and adjustable positioning of the target ring and ring support rod in the target bracket element of the target;

FIG. 16 is a side sectional view of the alignment indicator under circumstances where the ball coupler of the trailer is positioned directly over the hitch ball of the towing vehicle as indicated by vertical contact of the alignment indicator with the target ring, as illustrated in FIGS. 10 and 11 of the drawings; and

FIG. 17 is a side view, partially in section, of the alignment indicator in the position illustrated in FIGS. 12 and 13 of the drawings, wherein the alignment indicator is spaced from the target ring and disposed at an angled position with respect to the vertical, thus indicating misalignment of the ball coupler on the trailer with the hitch ball on the towing vehicle.

### DESCRIPTION OF THE PREFERRED EMBODIMENT

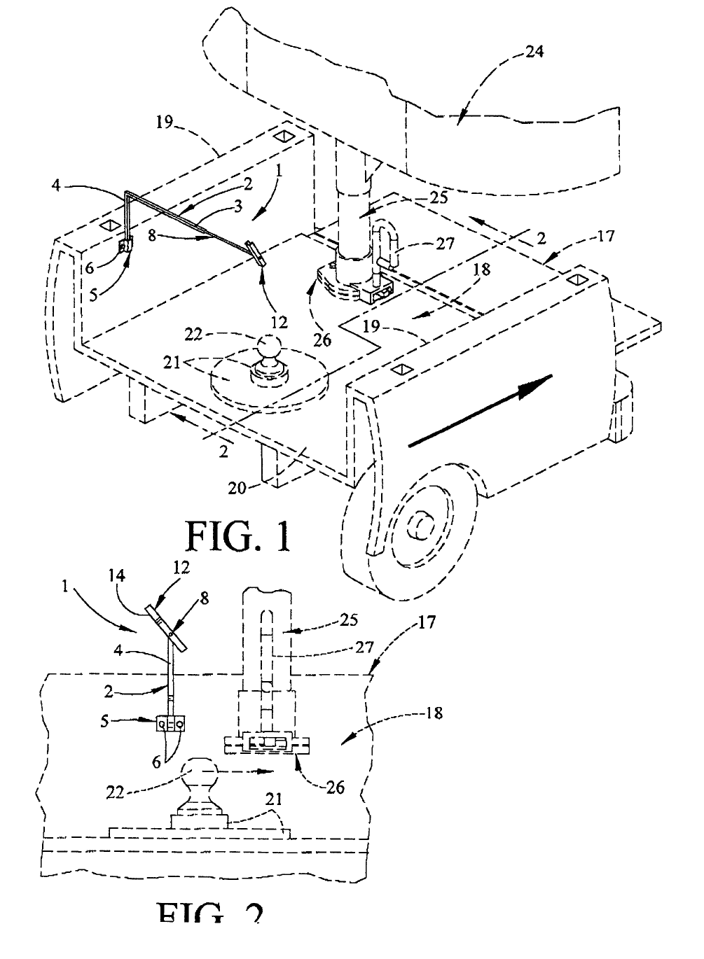

Referring initially to FIGS. 1, 2, 7 and 9 of the drawings, in a first preferred embodiment of the invention the trailer alignment apparatus is generally illustrated by reference numeral 1. The trailer alignment apparatus 1 is characterized by an L-shaped support bracket 2, typically constructed of box tubing and having a support bracket cavity 2b, as illustrated in FIG. 9. The support bracket 2 includes a horizontal bracket segment 3 and a vertical bracket segment 4, the latter of which is typically attached to the bed side 19 of the truck bed 18 in a pickup truck 17, by means of a support bracket cleat 5. Accordingly, an opening or vertical bracket segment seat 5b (FIG. 9) accommodates the vertical bracket segment 4 of the support bracket 2 to facilitate removable attachment of the trailer alignment apparatus 1 to the upper bed side 19 of the truck 17, (illustrated in phantom). The support bracket cleat 5 is typically attached to the top area of the bed side 19 by means of cleat bolts 6, which extend through cleat openings 5a in the support bracket cleat 5 and typically thread into the respective underlying truck bolt openings 7 located in the truck bed 18.

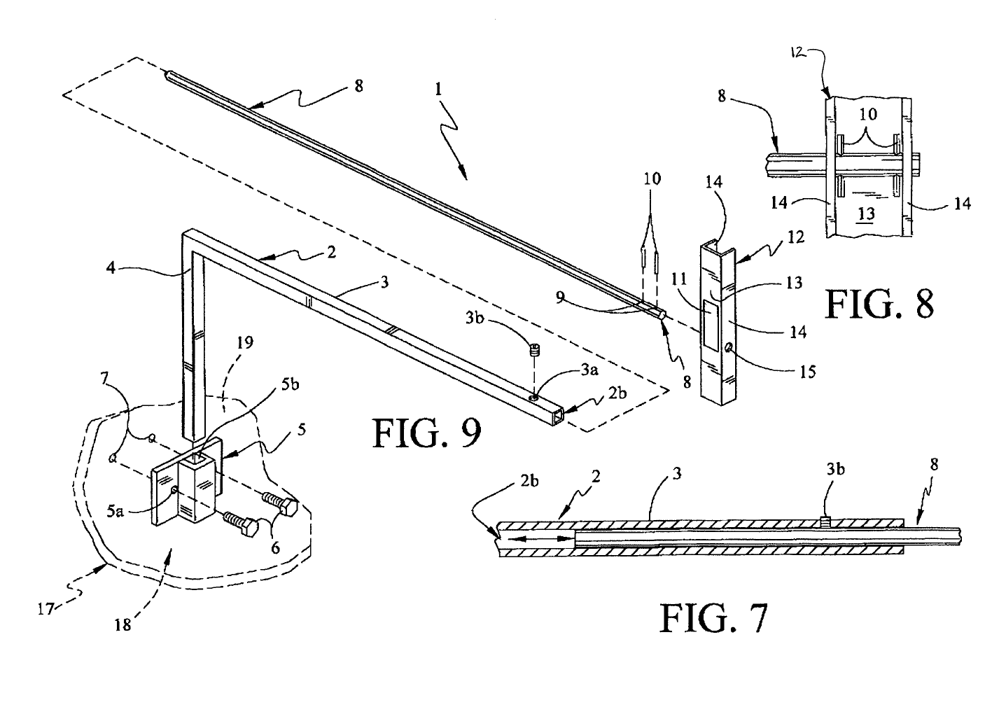

An adjusting rod 8 is slidably fitted into the support bracket cavity 2b of the horizontal bracket segment 3 of the support bracket 2 as illustrated in FIG. 7, and an allen screw 3b is threadably seated in a corresponding alien screw seat 3a, drilled and tapped in the horizontal bracket segment 3, to facilitate slidable and adjustable extension of the adjusting rod 8 from the horizontal bracket segment 3 of the support bracket 2. As further illustrated in FIGS. 1, 2, 8 and 9 of the drawings, an alignment indicator 12 is preferably characterized by a rectangular web 13 fitted with spaced-apart, parallel flanges 14 having aligned flange openings 15, for pivotally mounting on the extending end of the adjusting rod 8. Accordingly, as illustrated in FIGS. 8 and 9, a pair of pins 10 fit tightly through corresponding pin openings 9 in the adjusting rod 8 in fixed position to allow limited radial pivoting or rotation of the alignment indicator 12 on the adjusting rod 8. Accordingly, the parallel pins 10 are positioned on the adjusting rod 8 in spaced-apart relationship with respect to each other such that the lower ends of the pins 10 contact the web 13 of the alignment indicator 12 to facilitate normal resting of the alignment indicator 12 at an angled position with respect to a vertical axis, in the position illustrated in FIGS. 1 and 2. This normal resting position is assured since the distance between the adjusting rod 8 and the top edge of the alignment indicator 12 is greater than the distance between the adjusting rod 8 and the bottom edge of the alignment indicator 12, thus making the alignment indicator 12 top-heavy. Reflective tape 11 may be provided on the web 13 of the alignment indicator 12 to enhance viewing of the alignment indicator 12 from the cab of the truck, as illustrated in FIG. 4 and 9 and as hereinafter further described. As still further illustrated in FIGS. 1 and 2, the trailer alignment apparatus 1 is mounted on the bed side 19 of the truck 17 in such a manner that the alignment indicator 12 is positioned well above the truck bed 18 and above the hitch ball 22, which is typically attached to a ball mount plate 21 in the bed bottom 20 of the truck bed 18. The positioning of the alignment indicator 12 in such an elevated orientation allows clear viewing of the reflective tape 11 and the alignment indicator 12 from the tuck cab (not illustrated) as the operator of the truck 17 backs the truck 17 in the coupling operation.

Referring again to FIGS. 1 and 2 of the drawings, a gooseneck trailer 24 is fitted with a conventional, downwardly-extending gooseneck hitch post 25 having a gooseneck-type ball coupler 26 on the extending bottom end thereof and a conventional coupler release 27 is attached to the ball coupler 26, as illustrated in phantom. In FIGS. 1 and 2, the gooseneck hitch post 25 is illustrated in spaced-apart configuration with respect to the alignment indicator 12 of the trailer alignment apparatus 1 and the alignment indicator 12 is in the normal, angular resting position, thus indicating the relative misaligned positions of the bitch ball 22 on the truck 17 and the ball coupler 26 on the trailer 24 as backing of the pickup truck 17 continues.

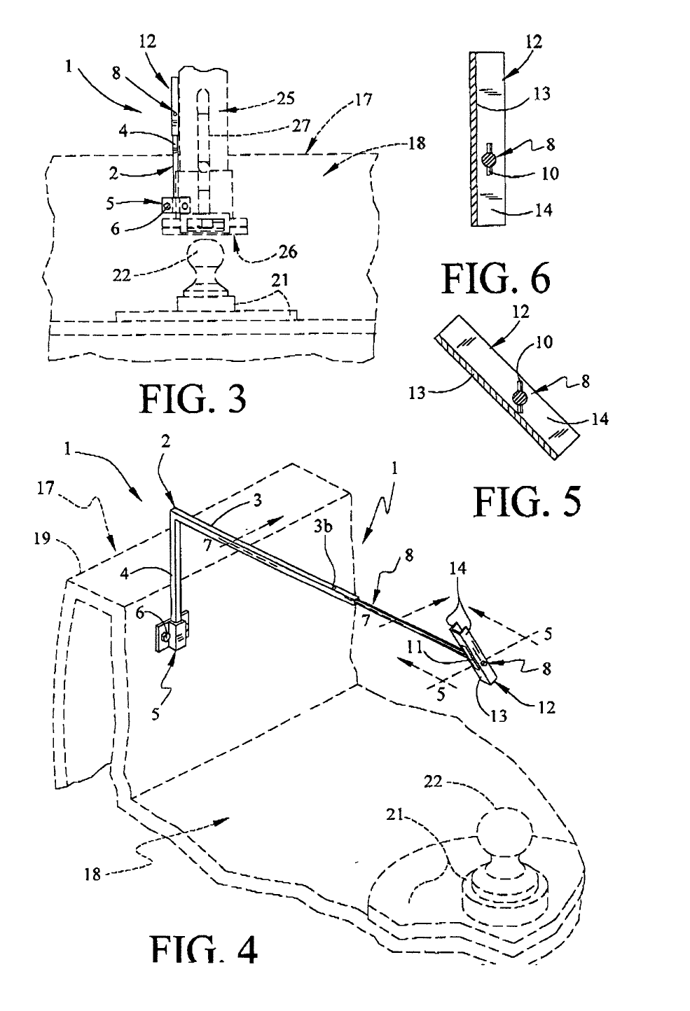

Referring now to FIG. 3 of the drawings, as the pickup truck 17 reaches the proper position for hitching the gooseneck trailer 24 to the pickup truck 17, the upper edge of the alignment indicator 12 initially contacts the downwardly-extending gooseneck hitch post 25 such that the alignment indicator 12 is pivoted from the angled, resting position of FIGS. 1 and 2, into the vertical configuration on the adjusting rod 8. This vertical position of the alignment indicator 12 illustrates that the gooseneck ball coupler 26 on the trailer 24 is then located directly above and in alignment with the underlying hitch ball 22 in the truck bed 18. Accordingly, this vertical position of the alignment indicator 12 as it seats against the gooseneck hitch post 25 indicates to the driver of the truck 17 that the trailer 24 may be lowered with full assurance that the gooseneck ball coupler 26 will engage the hitch ball 22 and facilitate coupling of the trailer 24 to the truck 17. The conventional coupler release 27 is designed to release this attachment at the proper time by manual operation.

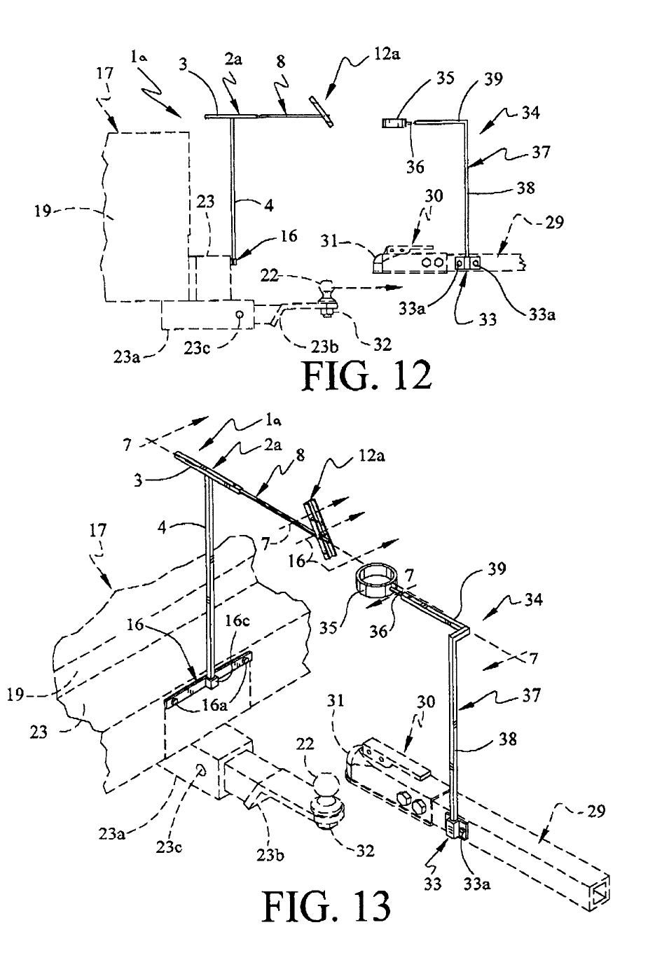

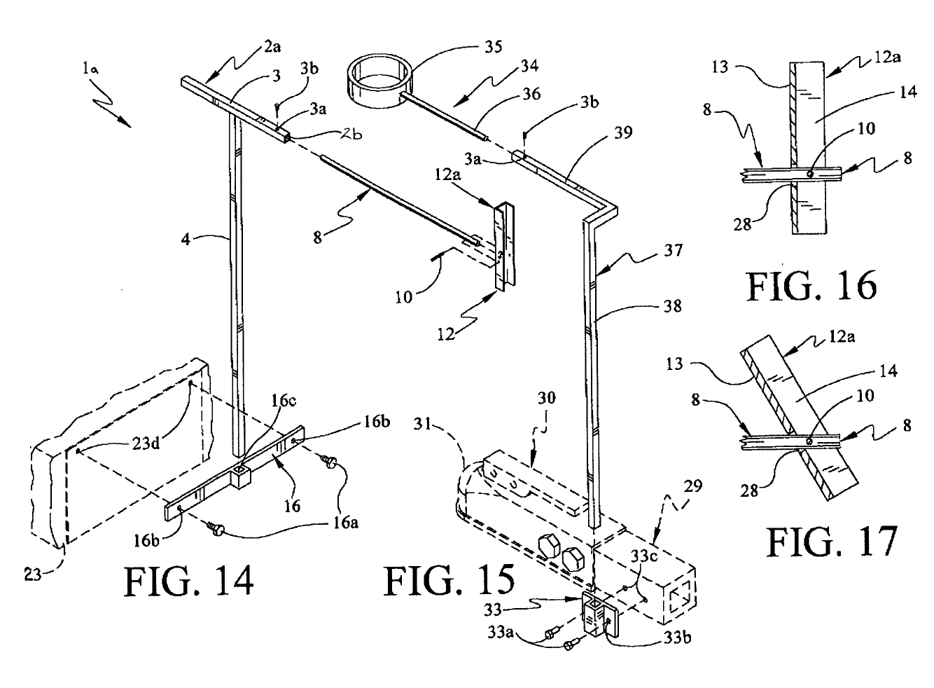

Referring now to FIGS. 12-17 of the drawings, in a second preferred embodiment of the invention the trailer alignment apparatus 1 a is connected to the rear bumper 23 of a truck 17, typically by means of an elongated indicator bracket 16, using bracket bolts 16a that fit through bracket bolt openings 16b in the indicator bracket 16 and typically thread into bumper bolt openings 23d, as illustrated in FIG. 14. The vertical bracket segment 4 of a T-shaped support bracket 2a extends vertically upwardly from preferably removable seating in a bracket seat 16c of the indicator bracket 16. The horizontal bracket segment 3 of the support bracket 2a typically extends from the vertical bracket segment 4 both forwardly and rearwardly, as well as horizontally, as further illustrated in FIGS. 12 and 13. Like the trailer alignment apparatus 1 illustrated in FIG. 9, the adjusting rod 8 is slidably positioned inside the support bracket cavity 2b of the horizontal bracket segment 3 and an allen screw 3b is seated in an allen screw seat 3a to slidably adjust the adjusting rod 8 in the horizontal bracket segment 3. The alignment indicator 12a is pivotally attached to the extending end of the adjusting rod 8 by means of a single pin 10, which extends through a pin opening (not illustrated) provided in the adjusting rod 8 and through aligned flange openings (not illustrated) provided in the alignment indicator 12a. Since the adjusting rod 8 projects through an elliptically-shaped aperture 28 (FIG. 16) in the web 13 of the al gent indicator 12a, the alignment indicator 12a is permitted to pivot in the plane of the adjusting rod 8 through an angle defined by the size of the elliptically-shaped aperture 28. As in the case of the alignment indicator 12 illustrated in FIGS. 1-9, the top segment of the alignment indicator 12a is loner than the bottom segment, measured from the point of pivot on the adjusting rod 8, to normally position the alignment indicator 12a as illustrated in FIGS. 12, 13 and 17 .

A companion target 34 is attached to the trailer tongue 29 (illustrated in phantom) of a trailer (not illustrated), rearwardly of a tongue-type ball coupler 30 which is fitted with a ball receptacle 31 (also illustrated in phantom) on the trailer tongue 29. The ball receptacle 31 is designed to receive and couple to a hitch ball 22, typically attached to a drawbar 23b by means of a ball nut 32, as illustrated in FIG. 13. The drawbar 23b is also typically removably seated in a drawbar mount 23a, fixed to the truck 17, by means of a drawbar pin 23c, in conventional fashion. The target 34 is characterized by an upward-standing vertical target bracket segment 38 of a target bracket 37, connected to the trailer tongue 29 by means of a trailer bracket 33 and trailer bracket bolts 33a, extending through trailer bracket bolt openings 33b in the trailer bracket 33 and threading into trailer openings 33c in the trailer tongue 29, as illustrated in FIG. 15. A horizontal target bracket segment 39 extends from the vertical bracket segment 38, toward the trailer alignment apparatus 1a mounted on the pickup truck 17, in application as hereinafter described. A ring support rod 36 is fitted inside the typically square tubing horizontal target bracket segment 39, as heretofore described with respect to the support bracket 2 and corresponding adjusting rod 8 of the trailer alignment apparatus 1 illustrated in FIGS. 7 and 9. Accordingly, the ring support rod 36 is linearly adjustable within the horizontal target bracket segment 39 and is typically secured in place by means of an allen screw 3b, threaded into an allen screw seat 3a, as heretofore described with respect to FIGS. 7 and 9. A target ring 35 is fitted to the extending end of the ring support rod 36 and is aligned horizontally with the bottom segment of the alignment indicator 12a, as illustrated in FIG. 13, and is disposed directly above the ball receptacle 31 of the ball coupler 30, as illustrated in FIG. 12.

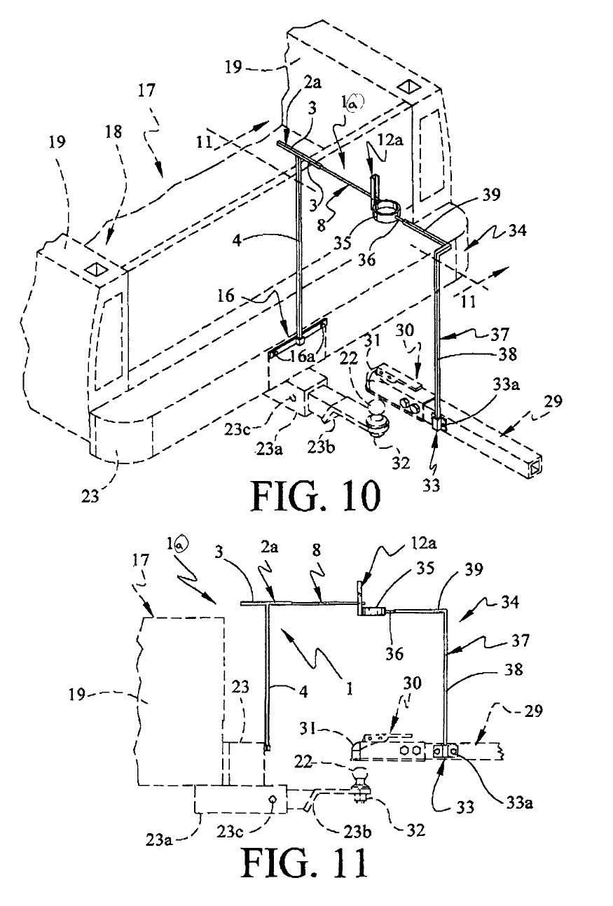

Referring next to FIGS. 10-13 of the drawings, in application of the trailer alignment apparatus 1a, as the truck 17 is backed toward the trailer tongue 29, the lower segment of the alignment indicator 12a approaches and finally contacts the target ring 35, mounted on the stationary trailer tongue 29, as illustrated in FIGS. 10 and 11. Under these circumstances, the stationary target ring 35 causes the moving indicator 12a to pivot on the pin 10 from the angled resting configuration of FIGS. 12 and 13 to the vertical configuration illustrated in FIGS. 10 and 11. Since the target ring 35 is positioned directly above the ball receptacle 31 of the trailer coupler 30 and the alignment indicator 12a is located directly above the hitch ball 22, the vertical configuration of the alignment indicator 12a indicates that the ball receptacle 31 of the ball coupler 30 is located directly above the hitch ball 22 and thus, is positioned for coupling to the hitch ball 22 by lowering the trailer tongue 29.

It will be appreciated by those skilled in the art that various techniques can be utilized for mounting the trailer alignment apparatus 1a on the rear bumper 23 of the truck 17 or on any other structural member of the truck 17 as desired, in order to configure the alignment indicator 12a directly above the rearwardly-extending hitch ball 22. As in the case of the truck alignment apparatus 1 illustrated in FIGS. 1-9, the indicator bracket 16 is preferably constructed such that the vertical bracket segment 4 of the T-shaped support bracket 2a is removably fitted into a socket, receptacle or bracket seat 16c in the indicator bracket 16 to facilitate removal attachment of the trailer attachment apparatus 1a to the truck 17. In like manner, the trailer bracket 33 may be designed such that the target 34 can be removably attached thereto and may even be fitted with a pivoting attachment mechanism to facilitate rearward pivoting of the target 34 with respect to the trailer tongue 29, as desired.

It will be further appreciated by those skilled in the art that the trailer alignment apparatus 1 and 1a in the respective embodiments set forth in this invention are each characterized by a simple, highly reliable and accurate device for aligning the hitch ball located on a truck or other towing vehicle with either a gooseneck-type ball coupler or the coupling mechanism on a conventional trailer. The device requires no mirrors and eliminates the necessity that a third party be present to guide the towing vehicle driver into the proper position such that the coupling device of the trailer is located directly above the hitch ball.

While the preferred embodiments of the invention have been described above, it will be recognized and understood that various modifications may be made in the invention and the appended claims are intended to cover all such modifications which may fall within the spirit and scope of the invention.

Having described my invention with the particularity set forth above, what is claimed is:

1. A trailer alignment apparatus for mounting in a towing vehicle and aligning a hitch ball on the towing vehicle with a ball coupler on a trailer, said trailer alignment apparatus comprising a support bracket for mounting on the towing vehicle and an alignment indicator pivotally attached to said support bracket above the hitch ball, said alignment indicator normally disposed in a first position at an angle with respect to a vertical axis, whereby said alignment indicator is pivoted from said first position to a substantially vertical second position responsive to backing of the towing vehicle toward the trailer and contact of the trailer with said alignment indicator.

2. The trailer alignment apparatus of claim 1 wherein said support bracket comprises a generally L-shaped support bracket having one end for attachment to the towing vehicle and an adjusting rod adjustably attached to the opposite end of said L-shaped support bracket from said one end and wherein said alignment indicator is pivotally attached to said adjusting rod.

3. The trailer alignment apparatus of claim 1 wherein said alignment indicator comprises a generally channel-shaped alignment indicator having a web and a pair of flanges projecting from said web in spaced-apart relationship with respect to each other and comprising openings provided in said flanges for accommodating said support bracket and facilitating pivoting of said alignment indicator on said support bracket.

4. The trailer alignment apparatus of claim 1 wherein:
(a) said support bracket comprises a generally L-shaped support bracket having one end for attachment to the towing vehicle and an adjusting rod adjustably attached to the opposite end of said L-shaped support bracket from said one end and wherein said alignment indicator is pivotally attached to said adjusting rod; and
(b) said alignment indicator comprises a generally channel-shaped alignment indicator having a web and a pair of flanges projecting from said web in spaced-apart relationship with respect to each other and comprising flange openings provided in said flanges for accommodating said support bracket and at least one pin seated in said adjusting rod for facilitating resting of said alignment indicator on said adjusting rod against said pin when said alignment indicator is in said first position.

5. The trailer alignment apparatus of claim 1 comprising a support bracket cleat for mounting on the towing vehicle and a vertical bracket segment seat provided in said support bracket cleat for removably receiving said support bracket and removably mounting said support bracket on the towing vehicle.

6. The trailer alignment apparatus of claim 5 wherein:
(a) said support bracket comprises a generally L-shaped support bracket having one end for attachment to the towing vehicle and an adjusting rod adjustably attached to the opposite end of said L-shaped support bracket from said one end and wherein said alignment indicator is pivotally attached to said adjusting rod; and
(b) said alignment indicator comprises a generally channel-shaped alignment indicator having a web and a pair of flanges projecting from said web in spaced-apart relationship with respect to each other and comprising flange openings provided in said flanges for accommodating said adjusting rod and at least one pin seated in said adjusting rod for facilitating resting of said alignment indicator on said adjusting rod against said pin when said alignment indicator is in said first position.

7. A trailer alignment apparatus for mounting in the bed of a pickup truck and aligning a hitch ball in the bed of the pickup truck with the ball coupler on the gooseneck hitch post of a gooseneck trailer, said trailer alignment apparatus comprising a support bracket having one end for mounting in the bed of the pickup truck and the other end of said support bracket disposed above the hitch ball and an alignment indicator pivotally attached to said other end of said support bracket, said alignment indicator disposed over the hitch ball in a normally angular configuration with respect to the vertical, wherein the alignment indicator is pivoted into a substantially vertical configuration responsive to backing of the pickup truck toward the trailer and contact between said alignment indicator and the gooseneck hitch post on the gooseneck trailer to indicate substantially vertical alignment of the ball coupler and the hitch ball.

8. The trailer alignment apparatus of claim 7 wherein said support bracket comprises a generally L-shaped support bracket having one end for attachment to the towing vehicle and an adjusting rod adjustably attached to the opposite end of said L-shaped support bracket from said one end and wherein said alignment indicator is pivotally attached to said adjusting rod.

9. The trailer alignment apparatus of claim 7 wherein sad alignment indicator comprises a generally channel-shaped alignment indicator having a web and a pair of flanges projecting from said web in spaced-apart relationship with respect to each other and flange openings provided in said flanges for accommodating said support bracket.

10. The trailer alignment apparatus of claim 7 wherein:
(a) said support bracket comprises a generally L-shaped support bracket having one end for attachment to the towing vehicle and an adjusting rod adjustably attached to the opposite end of said L-shaped support bracket from said one end and wherein said alignment indicator is pivotally attached to said adjusting rod; and
(b) said alignment indicator comprises a generally channel-shaped alignment indicator having a web and a pair of flanges projecting from said web in spaced-apart relationship with respect to each other and comprising flange openings provided in said flanges for accommodating said adjusting rod and at least one pin seated in said adjusting rod for facilitating resting of said alignment indicator on said adjusting rod against said pin when said alignment indicator is in said angular configuration.

11. The trailer alignment apparatus of claim 10 comprising a support bracket cleat for mounting on the towing vehicle and a vertical bracket segment seat provided in said support bracket cleat for removably receiving said support bracket and removably mounting said support bracket on the towing vehicle.

12. A trailer alignment apparatus for mounting on the rear of a towing vehicle having a hitch ball and aligning the hitch ball with the ball coupler on a trailer, said trailer alignment apparatus comprising a support bracket for attachment to the towing vehicle; an alignment indicator pivotally attached to said support bracket, said alignment indicator positioned above the hitch ball; and a target for attachment to the trailer, said target extending from the trailer over the ball coupler, wherein said alignment indicator is pivoted from a first position disposed at an angled configuration with respect to a vertical axis to a second position disposed at a vertical configuration on said support bracket responsive to backing of the towing vehicle toward the trailer and contact of said alignment indicator with said target.

13. The trailer alignment apparatus of claim 12 wherein said support bracket comprises a generally L-shaped support bracket having one end for attachment to the towing vehicle and an adjusting rod adjustably attached to the opposite end of said L-shaped support bracket from said one end and wherein said alignment indicator is pivotally attached to said adjusting rod.

14. The trailer alignment apparatus of claim 12 wherein said alignment indicator comprises a generally channel-shaped alignment indicator having a web and a pair of flanges projecting from said web in spaced-apart relationship with respect to each other and comprising an elliptically-shaped opening provided in said web for accommodating said support bracket and facilitating pivoting of said alignment indicator on said support bracket.

15. The trailer alignment apparatus of claim 12 wherein:
(a) said support bracket comprises a generally L-shaped support bracket having one end for attachment to the towing vehicle and an adjusting rod adjustably attached to the opposite end of said L-shaped support bracket from said one end and wherein said alignment indicator is pivotally attached to said adjusting rod; and
(b) said alignment indicator comprises a generally channel-shaped alignment indicator having a web and a pair of flanges projecting from said web in spaced-apart relationship with respect to each other and comprising an elliptically-shaped opening provided in said web for accommodating said support bracket and facilitating pivoting of said alignment indicator on said support bracket.

16. The trailer alignment apparatus of claim 15 comprising a support bracket cleat for mounting on the towing vehicle and a vertical bracket segment seat provided in said support bracket cleat for removably receiving said support bracket and removably mounting said support bracket on the towing vehicle.

17. The trailer alignment apparatus of claim 12 wherein said target comprises a target bracket having one end for mounting on the trailer and a target ring attached to the opposite end of said target bracket from said one end for contacting said alignment indicator.

18. The trailer alignment apparatus of claim 17 wherein said support bracket comprises a generally L-shaped support bracket having one end for attachment to the towing vehicle and an adjusting rod adjustably attached to the opposite end of said L-shaped support bracket from said one end and wherein said alignment indicator is pivotally attached to said adjusting rod.

19. The trailer alignment apparatus of claim 18 wherein said alignment indicator comprises a generally channel-shaped alignment indicator having a web and a pair of flanges projecting from said web in spaced-apart relationship with respect to each other and comprising an elliptically-shaped opening provided in said web for accommodating said adjusting rod and pivoting of said alignment indicator on said adjusting rod.

20. The trailer alignment apparatus of claim 19 comprising a ring support rod adjustably carried by said target bracket and wherein said target ring is attached to said ring support rod for adjusting the distance of said target ring from said target bracket.
